(19) United States
(12) Patent Application Publication
(10) Pub. No.: US 2006/0012120 A1
(43) Pub. Date: Jan. 19, 2006

(54) Positive reinforcement game

(76) Inventors: Peter M. Kash, New City, NY (US); Donna F. Kash, New City, NY (US)

Correspondence Address: JONES DAY, 222 EAST 41ST ST, NEW YORK, NY, 10017, US

(21) Appl. No.: 10/893,856

(22) Filed: Jul. 15, 2004

(51) Int. Cl. A63F 3/02; G09B 19/00

(52) U.S. Cl. 273/242; 434/238

(57) ABSTRACT

A positive reinforcement game is disclosed for assisting persons with ADHD or learning disabilities to modify and control their behaviors. The game includes a reward dispenser containing at least one reward tag. The person is allowed to retrieve one reward tag from the reward dispenser after completing a task. A new set of reward tags, with different rewards, may be added to the reward dispenser after the person completes a circuit on a game board.

### FIELD OF THE INVENTION

The present invention relates to games for entertainment and behavior modification. More specifically, the invention relates to games for assisting persons with learning disabilities or Attention Deficit Hyperactivity Disorder (ADHD) to modify and/or control their behaviors.

### DESCRIPTION OF THE RELATED ART

Games may be employed as effective tools that engage the attention of the player while teaching a concept, behavior, or skill. As the player interacts with the game, feedback is provided to the player by positive or negative reinforcement. Positive reinforcement rewards a player for a desired outcome or behavior. In contrast, negative reinforcement punishes the player when the outcome or behavior is less than desired.

Behavior-modifying games may be especially useful for children or adults diagnosed with Attention Deficit Hyperactivity Disorder (ADHD), also referred to as Attention Deficit Disorder (ADD). Approximately 4 to 6% of the U.S. population may have ADHD, which often manifests as poor sustained attention to tasks, impaired impulse control, or excessive activity and physical restlessness. Treatment of individuals with ADHD is usually focused on behavior therapy or counseling but may include medication where necessary.

An example of a device to help children with ADD is U.S. Pat. No. 5,288,233 issued to Green. Green discloses a device that provides both positive and negative reinforcement when a child completes a task within an allotted time period. When a child completes a task within the allotted time period, the child is rewarded with chips that may be accumulated and redeemed for a reward.

Another example is U.S. Pat. No. 5,725,381 issued to Kollath et al. Kollath et al. discloses a motivation system for children, consisting of motivation board that lists a schedule of tasks that may be performed by the child along with the number of credits the child receives for completing the task. The motivation board also includes a list of rewards and the number of credits the child must redeem to receive the reward. Undesirable behavior may also be listed on the motivation board along with the number of penalty credits that are subtracted from the child's account if the child demonstrates the undesirable behavior.

Another example is U.S. Pat. No. 6,042,383 issued to Herron. Herron discloses a portable electronic device that alerts the user at predetermined times to perform scheduled tasks and coaches and encourages the user in completing the task through text, audio, and animation. The device includes a timer and points are awarded to the user for completing the task within a pre-determined time interval. If the user takes longer than the pre-determined time interval to complete the task, a smaller number of points is awarded to the user. The user may redeem his/her points for a reward at the end of the day or week.

While the aforementioned examples may teach children organization, delayed gratification, and attention to completion of a task, they are not suitable for less developed or younger children or for children with more severe forms of ADHD. Therefore, there remains a need for devices or games that assist younger or less developed children to learn coping skills.

### SUMMARY OF THE INVENTION

One embodiment of the present invention is directed to a game providing positive reinforcement to a child for completing a task, the game comprising: at least one reward tag displaying a reward and a movement indicator and a reward dispenser containing the reward tag. The child retrieves one reward tag from the reward dispenser when the child completes the task and receives the reward displayed on the retrieved reward tag. The game may also include a game board displaying a game path (having a starting point and an ending point) and a figurine. The figurine is advanced along the game path according to the movement indicator displayed on the retrieved reward tag.

Another embodiment of the present invention is directed to a method of providing positive reinforcement to a child for completing a task. The method comprises: providing a reward dispenser containing at least one reward tag; allowing the child to retrieve one of the at least one reward tag from the reward dispenser after the child completes a task; and giving the child a reward displayed on the retrieved reward tag. The method may further include providing a game board displaying a game path, the game path having a starting point and an ending point; and allowing the child to advance a figurine along the game path according to a movement indicator displayed on the retrieved reward tag. The method may further include allowing the child to retrieve one of the at least one reward tag from the reward dispenser if the child completes three tasks in a day.

### BRIEF DESCRIPTION OF THE DRAWINGS

The invention will be described by reference to the preferred and alternative embodiments thereof in conjunction with the drawings in which:

FIG. 1 is a front view of the game board in an embodiment of the present invention;

FIG. 2 is a front view of the game board in another embodiment of the present invention;

FIG. 3 is an illustrative view of the figurines used with some embodiments of the present invention;

FIG. 4 is a front view of a reward dispenser used with some embodiments of the present invention; and

FIG. 5 is a front view of reward balls used with some embodiments of the present invention.

### DETAILED DESCRIPTION OF THE INVENTION

In some embodiments, the game of the present invention is a positive reinforcement game wherein the player, referred to hereinafter as the child, is rewarded for tasks accomplished. The child is not punished or penalized for negative behavior in these embodiments.

Tasks or behaviors that earn the child a reward when completed may include, for example, without being limiting, making his/her bed, brushing teeth, eating breakfast, putting on his/her shoes and coat, making the school bus on time, finishing his/her homework, finishing dinner, playing nicely with his/her siblings, taking a bath, going to bed on time, or behaving well when guests are visiting.

After the child has completed one of the tasks, the child is allowed to receive a reward and move a figurine on a game board. The child may be rewarded in the morning after completing a morning task, in the afternoon after completing an afternoon task, and in the evening after completing an evening task. The child may also receive a bonus reward if, for example, the child completes a morning, afternoon, and evening task.

Rewards that may be earned include for example, without being limiting, an extra hour of television during the week or weekend, control of the TV remote for an afternoon, or an outing with Mom or Dad for ice cream or dessert. Rewards may be changed when, for example, the child completes the path or circuit on the game board. The rewards may include previous rewards especially favored by the child or may include more significant prizes such as, for example, picking a place for dinner, a trip to a toy store, or going to the movies with Mom and Dad. Rewards may be pre-determined according to the age of the child. Rewards may also be selected by the parents according to the needs and desires of their child.

FIG. 1 is a front view of the game board 100 in one embodiment of the present invention. The game board 100 has a game field 110 mounted on a support 120. The support 120 may be a rigid or semi-rigid material that optionally includes a fold (not shown) that allows the game board 100 to be folded for easier storage. Alternatively, the support 120 may be a flexible material that allows the game board to be rolled up for easier storage. In another embodiment, the game field 110 may be printed or embossed directly on the support 120.

The game board 100 may be deployed horizontally or vertically. In one embodiment, the game board 100 is deployed horizontally and has a rigid or semi-rigid support 120. In another embodiment, the game board 100 is deployed vertically and is supported against a vertical surface such as for example, a wall or door, by magnets, tacks, tape, or other such methods or devices.

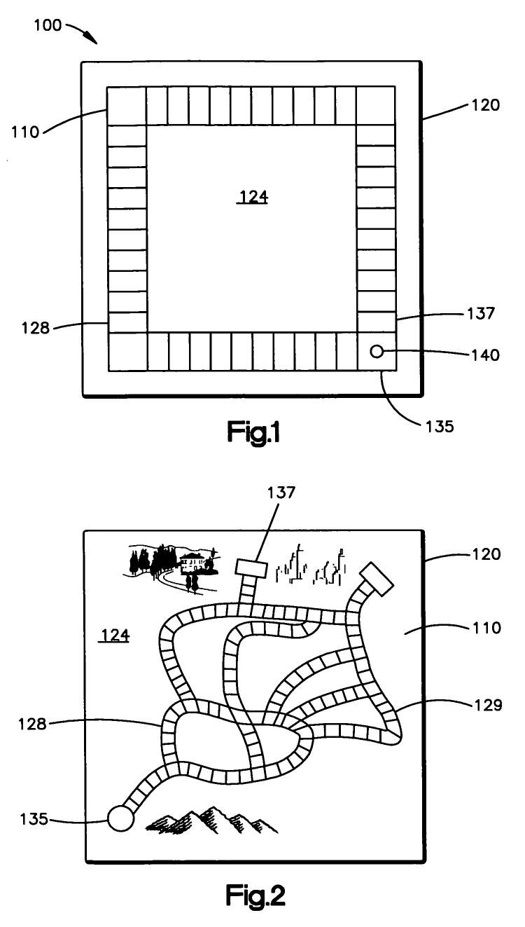

The game field 110 includes a background area 124 and a game path 128. The background area 124 may be any design, pattern, theme, or print that appeals to a young child. Illustrative examples of background designs may include a favorite cartoon or story character, animal or flower themes, or local landmarks such as the Ramble. The game path 128 may be a closed loop as shown in FIG. 1 or may be an open path having a starting point 135 and an ending point 137 as illustrated in FIG. 2. The game path 128 consists of path segments 129. Each path segment 129 is adjacent to at least one other path segment.

In one embodiment, each path segment 129 is color-coded to match a color on the reward tags. Each path segment 129 may also be labeled with a reward to match one of the reward tags. In some embodiments, the color of each path segment 129 corresponds to a number representing the number of path segments the child is allowed to advance his/her figurine. As an illustrative example, the color green may represent an advance of one path segment, the color red may represent an advance of two path segments, the color blue may represent an advance of three path segments, and so on. In some embodiments, each path segment and reward tag is labeled with the number of path segments corresponding to the color of the path segment or reward tag.

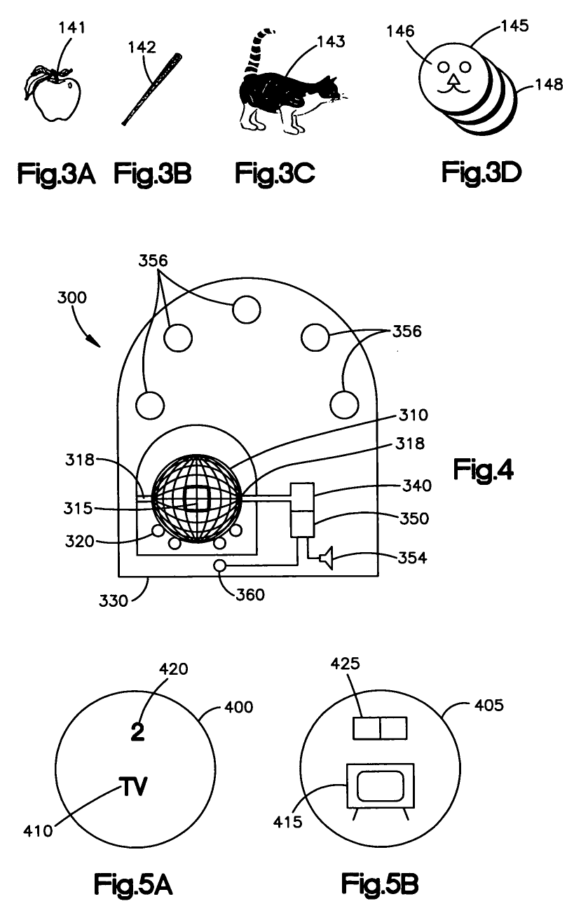

Each child advances along the game path 128 by moving his/her figurine 140 the appropriate number of path segments. The figurine may be a scaled three-dimensional object familiar to the child such as, for example, an apple 141, a bat 142, a cat 143, a doll, and so forth. FIG. 3 is a perspective view illustrating figurines 140. In some embodiments, the figurine may be star-shaped or disk-shaped 145 and adapted to allow mounting a photo 146 of the child or the child's pet on the face of the disk-shaped figurine. In some embodiments where the game board is vertically mounted, a magnet 148 may be disposed on the figurine such that the figurine is held against the game board by the magnet.

FIG. 4 is a schematic view of the reward dispenser 300 in some embodiments of the present invention. The dispenser 300 has a rotatable cage 310 that contains a plurality of reward tags 320. In some embodiments, the cage 310 is substantially spherically shaped although other shapes may be used. The cage 310 has a door 315 that may be opened to retrieve a reward tag 320 and closed to contain the reward tags when the cage is rotated. The cage is rotated about an axis 318 that is supported by a housing 330. In some embodiments, the rotation of the cage 310 is driven by an electric motor 340 controlled by a controller 350. The controller 350 controls a speaker 354 to play pre-stored sounds. In some embodiments, the controller 350 controls a plurality of lights 356 disposed on the housing 330. An input device 360 is in electrical communication with the controller 350 and when activated, causes the controller 350 to rotate the cage. The controller 350 may cause pre-stored sounds to be played through speaker 354 and activate the plurality of lights 356.

FIG. 5 is a front view of a reward tag 400, 405 used in some embodiments of the present invention. Reward tag 400, 405 may be substantially spherical in shape. In alternative embodiments, the reward tag may polyhedral, ellipsoidal or any other shape that allows a tumbling action in the reward dispenser. The reward tag 400 may have a reward 410 printed on the surface of the reward tag as a word or phrase or as a reward icon 415. The reward 410 or reward icon 415 represents the reward that the child receives for completing a task. The reward 410 or reward icon 415 may be pre-printed on the surface of the reward tag 400, 405 or applied as pre-printed stickers. Reward tags without pre-printed rewards may also be provided to allow the parent to write customized rewards on the reward tag. The customized rewards may be any reward especially favored by the child or deemed appropriate by the parent.

The reward tag 400 may also display a movement indicator, for example, a number 420 printed on the surface of the reward tag 400 representing the number of path segments the child may advance his/her figurine on the game board. In other embodiments, the number of path segments may be represented as an movement icon 425.

Reward tags may optionally be color-coded to correspond to the number of path segments the child's figurine is advanced on the game board. As an illustrative example, the reward tag may be colored green if the movement number is one, red if the movement number is two, blue if the movement number is three, and so forth. Other color-coding schemes apparent to one of skill in the art should be understood to be encompassed by the scope of the present invention.

In some embodiments, the child begins by picking a figurine and placing the figurine on the starting path segment of the game board. After completing a morning, afternoon, or evening task, the child is allowed to retrieve a reward tag from the reward dispenser. If the child does not complete a task, the child is not allowed to retrieve a reward tag from the reward dispenser. The child, however, is not punished or penalized for not completing the task or exceeding a time limit to perform the task, thereby rendering the game a positive reinforcement game only.

The child is immediately given the reward indicated on the reward tag. If the reward can not be given immediately, the reward tag is placed on the game board to remind the child and parents that an outstanding reward must be rendered as soon as possible. Once the reward has been given, the reward tag is returned to the reward dispenser.

The child advances his/her figurine by the amount indicated on the reward tag. The number of segments comprising the path and the movement numbers on the reward tags are set such that the child is able to complete a circuit or path in approximately four to eight weeks. When the child completes a circuit, the reward tags in the reward dispenser are replaced such that new rewards may be earned by the child.

Bonus rewards may be earned by the child by, for example, completing a morning and afternoon and evening task in one day. Bonus rewards may also be earned on the weekends for completing additional tasks, such as for example, good behavior when invited guests are in the house. Bonus rewards may also be allowed in order to allow the child to complete the circuit on the game board within a time determined by the parent.

Having thus described at least illustrative embodiments of the invention, various modifications and improvements will readily occur to those skilled in the art and are intended to be within the scope of the invention. Accordingly, the foregoing description is by way of example only and is not intended to be limiting. The invention is limited only as defined in the following claims and the equivalents thereto.

1. A game providing positive reinforcement to a child for completing a task, the game comprising:
at least one reward tag, the reward tag displaying a reward and a movement indicator; and
a reward dispenser containing the at least one reward tag,
wherein the child retrieves one reward tag from the reward dispenser when the child completes the task and receives the reward displayed on the retrieved reward tag.

2. The game of claim 1 further comprising:
a game board displaying a game path, the game path having a starting point and an ending point; and
a figurine,
wherein the figurine is advanced along the game path according to the movement indicator displayed on the retrieved reward tag.

3. The game of claim 1 wherein the reward tag is substantially spherically shaped.

4. The game of claim 1 wherein the reward is pre-determined.

5. The game of claim 1 wherein the reward is customizable by a parent.

6. The game of claim 1 wherein the child receives the reward displayed on the retrieved reward tag immediately after retrieving the reward tag.

7. The game of claim 1 wherein the reward dispenser further comprises:
a cage containing the at least one reward tag;
a motor configured to rotate the cage; and
a controller for controlling the motor.

8. The game of claim 7 wherein the reward dispenser further comprises a speaker controlled by the controller, the speaker playing sounds while the cage is rotated.

9. The game of claim 7 wherein the reward dispenser further comprises at least one light controlled by the controller while the cage is rotated.

10. The game of claim 2 wherein the reward tag is color-coded to the movement indicator.

11. The game of claim 2 wherein a new reward tag is added to the reward dispenser when the figurine is moved onto the ending point.

12. The game of claim 11 wherein the reward indicated on the new reward tag is not indicated on any of the at least one reward tag.

13. A method of providing positive reinforcement to a child for completing a task, the method comprising:
providing a reward dispenser containing at least one reward tag;
allowing the child to retrieve one of the at least one reward tag from the reward dispenser after the child completes a task; and
giving the child a reward displayed on the retrieved reward tag.

14. The method of claim 13 further comprising:
providing a game board displaying a game path, the game path having a starting point and an ending point; and
allowing the child to advance a figurine along the game path according to a movement indicator displayed on the retrieved reward tag.

15. The method of claim 14 further comprising adding a new reward tag to the reward dispenser when the figurine is advanced to the ending point, wherein the new reward tag displays a new reward that is different from the reward displayed on the at least one reward tag.

16. The method of claim 13 further comprising allowing the child to retrieve one of the at least one reward tag from the reward dispenser if the child completes three tasks in a day.

17. A game providing positive reinforcement to a child for completing a task, the game comprising:
at least one reward tag, the reward tag displaying a reward and a movement indicator;
a cage containing the at least one reward tag;
a motor configured to rotate the cage; and
a controller for controlling the motor.
wherein the child retrieves one reward tag from the cage, after rotating the cage by activating the controller, when the child completes the task and receives the reward displayed on the retrieved reward tag.

18. The game of claim 17 wherein the reward is determined by a parent.

19. The game of claim 18 wherein the parent allows the child to retrieve one reward tag from the cage as a bonus.

20. The game of claim 17 further comprising a speaker controlled by the controller, the speaker configured to play sounds while the cage is rotated.
